(19) United States
(12) Patent Application Publication
(10) Pub. No.: US 2010/0301022 A1
(43) Pub. Date: Dec. 2, 2010

(54) METHOD OF LASER-WELDING USING THERMAL TRANSFER DEPOSITION OF A LASER-ABSORBING DYE

(75) Inventors: Martin Rickwood, Clarks Green, PA (US); William H. Cawley, Clarks Summit, PA (US)

Correspondence Address: Design IP, A Professional Corporation, 5100 W. Tilghman Street, Suite 205, Allentown, PA, 18104, US

(73) Assignee: GENTEX CORPORATION, Carbondale, PA (US)

(21) Appl. No.: 12/475,822

(22) Filed: Jun. 1, 2009

(51) Int. Cl. B23K 26/20

(52) U.S. Cl. 219/121.64

(57) ABSTRACT

Using a thermal transfer technique to transfer a laser-absorbing dye from a transfer medium to a receiving substrate, then activating the dye by exposure to a laser source to affect a weld between the receiving substrate and an adjacent second substrate at a desired joint region. The same laser may optionally be used to both transfer the laser-absorbing dye to a receiving substrate and weld the receiving substrate and the second substrate.

### BACKGROUND OF THE INVENTION

The invention relates to a method for applying a laser-absorbing dye to a substrate, which is then used to laser-weld the substrate to another part.

Depositing a light-absorbing dye (hereinafter “absorber dyes”) onto a substrate, then affecting a weld between the substrate and another substrate by activating the absorber dye with a laser is known in the art. As taught in U.S. Pat. No. 7,201,963, conventional laser welding methods use “wet” methods to apply the absorber dye to the substrate, meaning that the absorber dye is applied to the substrate via a liquid in which the absorber dye is dissolved or is in small particulate form. Such methods include, for example, liquid dispensing, dip coating, painting, printing, and spraying.

The drawbacks of the use of wet absorber dye application methods are numerous. First, “wet” methods are unable to achieve highly precise deposition of the absorber dye due to the propensity of the absorber dye to smear, run, or infuse into the surfaces of the substrate. The spreading of dyes is traditionally controlled by adding large quantities of resins, binders or other thickening agents to the dyes. However, these thickening agents detract from the weldability of substrates on which the absorber dye is deposited. Further, liquid deposition methods require the use of a carrier solvent to dissolve the dye to form an ink. The use of solvents is not desirable in some products, such as in some medical products, making the use of traditional liquid dispensing techniques objectionable to the manufacturers of the products. In addition, the use of solvents is also generally undesirable because solvent vapors and waste require special handling.

It is also known in the art to apply an absorber dye to a substrate either as a tape or film or attached to a carrier film that remains in the joint after welding. The former process presents difficulties in handling and placement of the film, as well as the necessity to make the absorber dye film thicker or wider than needed for welding purposes. The latter method has the drawback of requiring the addition of another component to the welding process.

There is a need for a highly precise and solvent-free thermal transfer technique for depositing laser-absorbing dyes to a substrate for purposes of creating a weld-enabled region.

### SUMMARY OF THE INVENTION

In one respect, the invention comprises a method comprising: transferring a first portion of a layer of absorber material from a first surface of a transfer medium to a first portion of a first substrate by exposing the first portion of the layer of absorber material to a thermal energy source while the first portion of the layer of absorber material is in contact with the first portion of the first substrate, the absorber material being in solid phase immediately prior to the transferring step; and welding the first portion of the first substrate to a second substrate by exposing the first portion of the layer of absorber material to a laser while the first portion of the first substrate is in contact with the second substrate.

In another respect, the invention comprises a method comprising: transferring a first portion of a layer of absorber material from a first surface of a transfer medium to a first portion of a first substrate by exposing the first portion of the layer of absorber material to a laser while the first portion of the layer of absorber material is in contact with the first portion of the first substrate, the absorber material being in solid phase immediately prior to the transferring step and the laser being operated in a deposition mode during the transferring step; and welding the first portion of the first substrate to a second substrate by exposing the first portion of the layer of absorber material to the laser while the first portion of the first substrate in contact with the second substrate, the laser being operated in a welding mode, the welding mode having a greater energy density than the deposition mode.

### BRIEF DESCRIPTION OF THE DRAWINGS

The present invention will hereinafter be described in conjunction with the appended drawing figures wherein like numerals denote like elements.

FIG. 1 is a flowchart showing the basic process steps of the present invention;

FIGS. 2A-2C are schematic views of a work station having a contact transfer head and a fully coated transfer medium before, during, and after the dye transfer step of the present invention;

FIGS. 3A-3C are schematic views of a work station having a contact transfer head and a transfer medium with a precisely laid dye pattern before, during, and after the transfer step;

FIGS. 4A-4C are schematic views of a work station having a laser source and a fully coated transfer medium before, during, and after the transfer step;

FIGS. 5A-5C are schematic views of a work station having a laser source and a transfer medium with a precisely laid dye pattern before, during, and after the transfer step;

FIGS. 6A-6C are schematic views of a work station with a laser source, a mask, and a fully coated transfer medium before, during, and after the transfer step; and

FIGS. 7A-7F are schematic views of a work station having a laser source with adjustable intensity settings that is used for both the dye transfer and welding steps of the process.

### DETAILED DESCRIPTION OF THE PREFERRED EMBODIMENTS

The ensuing detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing the preferred exemplary embodiments of the invention. It being understood that various changes may be made in the function and arrangement of elements without departing from the spirit and scope of the invention, as set forth in the appended claims.

To aid in describing the invention, directional terms may be used in the specification and claims to describe portions of the present invention (e.g., upper, lower, left, right, etc.). These directional definitions are merely intended to assist in describing and claiming the invention and are not intended to limit the invention in any way. In addition, reference numerals that are introduced in the specification in association with a drawing figure may be repeated in one or more subsequent figures without additional description in the specification in order to provide context for other features.

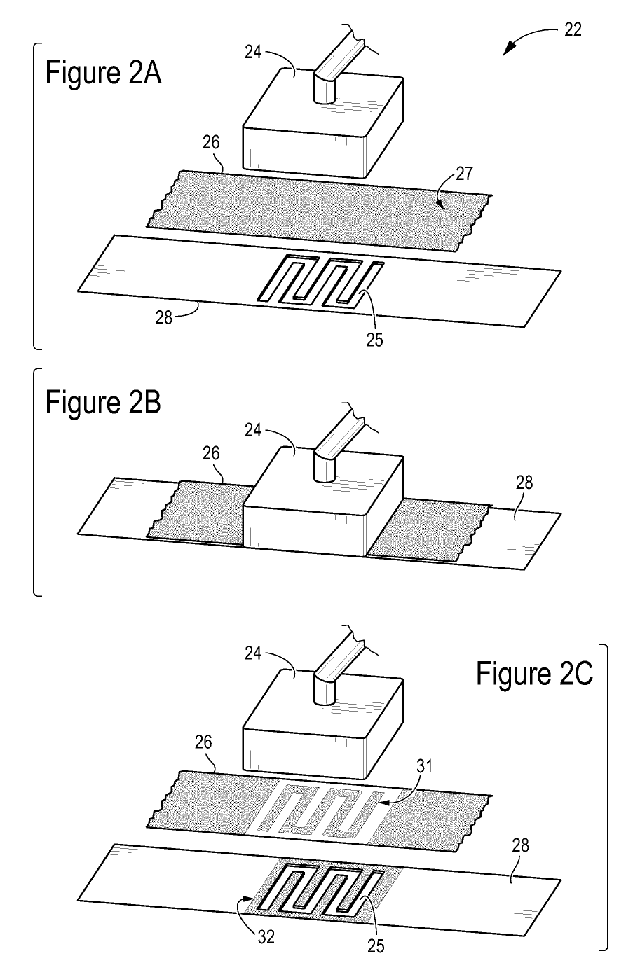

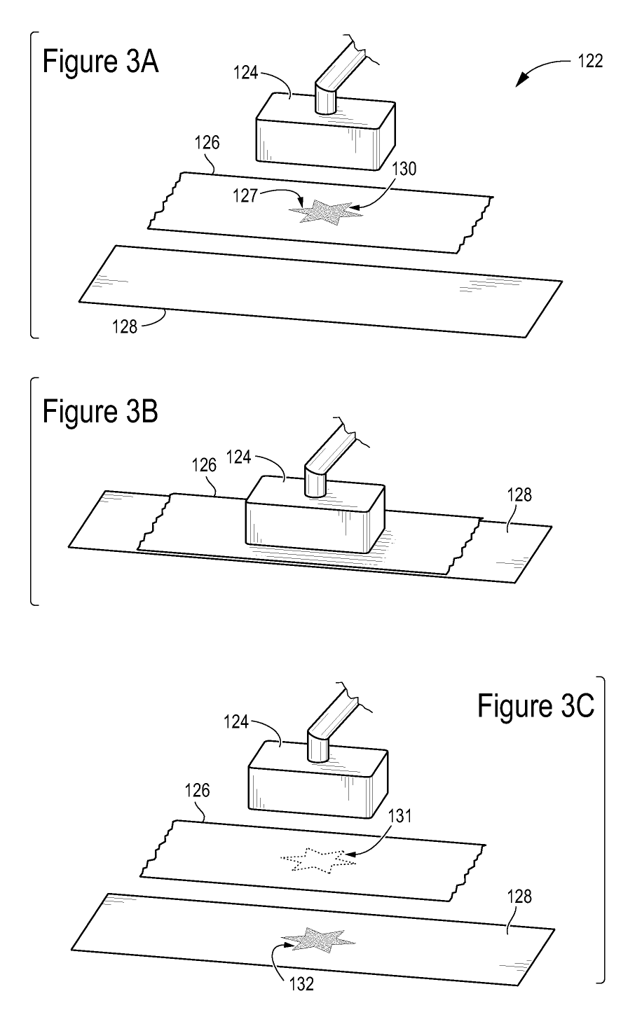

In this embodiment, elements shared with the first embodiment (work station 22) are represented by reference numerals increased by factors of 100. For example, the transfer medium 26 in FIGS. 2A-2C corresponds to the transfer medium 126 in FIGS. 3A-3C.

The present invention comprises affecting a laser-weld by activating an absorber dye that has been applied to the substrate being welded using a “thermal transfer process.” In general terms, a thermal transfer process involves applying a layer of an “absorber material” to a thin film (referred to herein as a “transfer medium”), then using a thermal energy source to transfer the absorber material from the transfer medium to the surface of a substrate to be welded. The absorber material preferably consists of an absorber dye.

Although using an absorber material that consists solely of one absorber dye is preferred, some applications may require inclusion of more than one absorber dye and/or other materials in the absorber material. For example, a binder component may be included to maintain adherence of the absorber dye(s) on the transfer medium and/or the substrate. In addition, a low melting material (or “carrier”) may be added to solvate the absorber dye(s) and aid in temporary liquefaction of the absorber material as it is transferred from the transfer medium to the substrate. Preferably, the low melting material is selected to have little or no impact on the nature of the weld. A thermoplastic polymer that is similar in composition to the substrate(s) being welded is one example of a suitable low melting material.

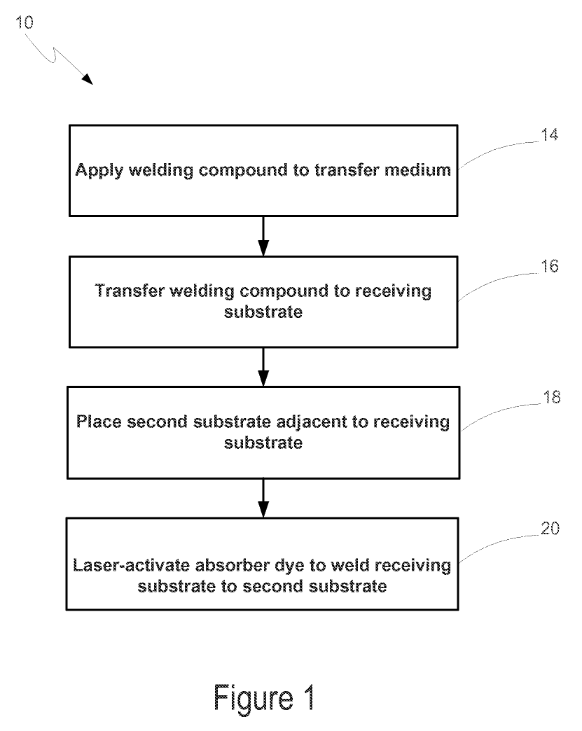

One example of basic process steps 10 for performing the present invention are provided in FIG. 1. First, the absorber material (including an absorber dye) is applied to the transfer medium (step 14). Then a thermal energy source is used to transfer the absorber material to a receiving substrate (step 16). For most thermal transfer methods, it is preferable that the portion of the absorber material to be transferred be in contact with (or at least in very close proximity to) the receiving substrate during step 16. The receiving substrate is then placed in contact with a second substrate (step 18). A laser is then used to activate the absorber dye (step 20), and creates a weld between the receiving substrate and the second substrate in the area in which the absorber material was deposited onto the receiving substrate in step 16 (hereinafter referred to as the “weld area” or “weld region”).

Stated more precisely, in step 20, the absorber dye absorbs energy from the laser and transfers thermal energy to the substrates in the weld region, causing a controlled melting and co-mingling of the two substrates in the weld region. The weld is formed upon cooling. In most embodiments, the absorber dye decomposes during step 20, leaving little or no absorber dye in the weld region at the completion of the welding process. In embodiments in which the receiving substrate and second substrate are not made of the same material, the joining of the receiving substrate and second substrate in the weld region is more accurately described as a bond. For the purposes of this application, the term “weld” is meant to include absorber dye-based bonding of a receiving substrate and a second substrate even if the receiving and second substrate are made of different materials.

It is preferable that the absorber dye have high absorption and large extinction coefficients at the wavelength that is emitted by the laser used to “activate” the absorber dye. It is also preferable that the absorber dye have low absorption and low coloration in wavelength ranges other than the wavelength emitted by the laser, particularly within the visible spectrum.

Where it is critical to minimize opacity, such as, for example, in goggle or visor applications, it is desirable to use an absorber dye with photopic values within a small tolerance range of water-white polycarbonate, such as, for example, the family of visible-spectrum Clearweld™ absorber dyes, produced by Gentex Corporation of Carbondale, Pa.

The transfer medium is preferably a thin film having a high degree of dimensional stability under the heat and pressure to which it will be exposed during the thermal transfer process. It is preferable that the transfer medium be arranged in a spool that can be easily fed to a work station 22 area (see generally FIGS. 2A-2C). It should be understood, however, that the transfer medium may also be an individual sheet of a material. In applications where a contact thermal transfer head is used for transfer of the absorber dye from the transfer medium to the receiving substrate (explained in greater detail herein), the transfer medium is preferably smooth, so that the transfer medium slides easily when in contact with the contact transfer head and the part to which the absorber is to be transferred. It should be understood that the optimal transfer medium composition and thickness is based on the particular application.

Examples of possible transfer medium compositions include polyethylene (“PE”), polytetrafluoroethylene (“PTFE”), polyethylene terephthalate (“PET”), biaxial oriented PET, aluminum foil and aluminum coated PET film. The transfer medium may optionally be pretreated to improve adherence of the absorber material. A pretreated PET film approximately 4-6 microns thick, an untreated PET film approximately 20-25 microns thick, aluminum films approximately 20-50 microns thick, and an aluminum-coated PET film approximately 4-6 microns thick have been found to produce acceptable results.

Optionally, the absorber material may also include a thermoplastic resin carrier compound which is preferably compatible with (i.e. soluble in) the receiving substrate material. For example, a polycarbonate thermoplastic resin carrier compound would be suitable for use on a polymethyl methacrylate substrate. The thermoplastic resin carrier compound facilitates transfer of the absorber dye from the transfer medium to the receiving substrate, particularly in embodiments in which the absorber dye has a high melting temperature (e.g., above 200 degrees C.). The thermoplastic resin carrier compound can also fill impressions or gaps in the surface of the receiving substrate, thereby improving weld integrity.

For most applications it is preferable that the absorber material be applied only to one surface (side) of the transfer medium. It should be understood, however, that it is possible to have a transfer medium with absorber dye on both surfaces, which would allow for the transfer of the absorber dye to two substrates at once.

The receiving substrate and second substrate (i.e., the parts being welded by the absorber material) may each comprise any material that is transmissive of the laser used in step 20 and having a melting point that results in localized melting when in the weld region during step 20. Thermoplastics, such as polyesters, polyamides, polyolefins, polyurethanes and polycarbonates are examples of substrates which are compatible with the welding methods of the present invention. Although the composition of the receiving substrate and the second substrate need not be identical, these two substrates should be compatible in terms of miscibility, thermal expansion characteristics, and melting temperatures.

As will be described in greater detail herein, there are a number of methods that can be used to apply the absorber material to the transfer medium, including, but not limited to, screen printing, spraying, blade coating, gravure printing, rotogravure printing, electrophotography, and electrography. In embodiments in which the absorber material coats an entire side of the transfer medium with the absorber material, the resolution (precision) of the method used to apply the absorber material to the transfer medium and the precision of the alignment between the transfer medium and the receiving substrate are not critical. In embodiments in which the absorber material is applied to the transfer medium in a defined pattern that is fully transferred to the receiving substrate, the accuracy of the weld region is much more dependent on the resolution (precision) of the method used to apply the absorber material to the transfer medium and the precision of the alignment between the transfer medium and the receiving substrate. Accordingly, in embodiments where a defined absorber material pattern is used on the transfer medium and a highly-accurate weld region is needed, a high-accuracy method for applying the absorber material to the transfer medium is preferably used. Rotogravure printing has been found to be an accurate and cost-effective method to apply the absorber material to the transfer medium.

The description that follows and FIGS. 2A through 7F illustrate several embodiments of the transfer and welding steps of the present invention. The thermal energy sources described herein can be classified in two general categories: (a) thermal energy sources that are placed in contact with the transfer medium during the transfer of the absorber material to the receiving substrate (hereinafter “contact” thermal energy sources) and (b) thermal energy sources that are not placed in contact with the transfer medium during the transfer of the absorber material to the receiving substrate (hereinafter “non-contact” thermal energy sources).

Referring generally to FIGS. 2A-2C, a work station 22 comprising a contact transfer head 24 located above a transfer medium 26 that is fully coated with an absorber material 27 is shown. Below the transfer medium is the receiving substrate 28, which has a channel 25 formed therein. In FIG. 2A, the contact transfer head 24, transfer medium 26, and receiving substrate 28 are shown in non-adjacent positions.

In FIG. 2B, the contact transfer head 24, which has been activated, is placed in contact with the transfer medium 26. The transfer medium 26 is also in contact with the receiving substrate 28, except in the area of the channel 25. The contact transfer head 24 acts to provide a source of thermal energy and pressure to the transfer medium 26 sufficient to affect a transfer and deposition of the absorber material 27 to the receiving substrate 28. It should be understood that the absorber material 27 is in a solid state at all times during the process, except when it is being transferred to the receiving substrate 28, at which point it has been heated sufficiently to briefly transition it to a melted or softened state.

In FIG. 2C, the contact transfer head 24, transfer medium 26, and receiving substrate 28 have again been separated. FIG. 2C shows the surface of the transfer medium 26 with the removed dye pattern 31. The removed dye pattern 31 corresponds with the received dye pattern 32 that has been deposited onto the surface of the receiving substrate 28. Notably, the absorber material 27 was not transferred to the channel 25.

The contact transfer head 24 may be of many different types, for example, a thermal printing head, a resistive heating element, or a silicone rubber stamp. For applications where precision is less important, the contact transfer head 24 may alternatively be a hot stylus, for example a machine-guided or hand-held heating tool. Thermal printing heads have been used for preparation of high-quality photographic prints, and are also used as part of the D2T2 process for production of credit cards. Commonly used thermal printing heads have a resolution of approximately 300 dots per inch (“dpi”). That is, these thermal printing heads are capable of depositing pixels having a major dimension of approximately 80 microns. Higher resolution thermal printing heads are now becoming commercially available. These thermal printing heads can achieve resolutions greater than 1000 dpi (25 microns).

In the alternative, the contact transfer head 24 could be a resistive heating element comprised of electrodes. Where a metallic-based material is used for the transfer medium 26, for example an aluminum-PET film, the electrodes are capable of generating resistive heating in the transfer medium 26. The electrically-generated heat affects the transfer of the absorber material 27 to the receiving substrate 28. Resistive transfer of the absorber material 27 is a faster process than conventional thermal printing because cool down time for the contact transfer head 24 is not required. Instead, the excess thermal energy created by the resistive element reacting with the transfer medium 26 is carried away in the transfer medium 26.

In another embodiment, the contact transfer head 24 could be a silicone rubber stamp. In a typical commercial application, the desired dye pattern 30 (see FIG. 3A) is molded into a heat-conductive silicone die. The silicone die is attached to a metal plate, which is affixed to a heated surface on a platen. Thermal energy is transferred to the silicone die, which is pressed down against the transfer medium 26 that has been registered over the receiving substrate 28. The heated silicone die transfers the absorber material 27 from the transfer medium 26 to the receiving substrate 28. A transfer medium 26 made of PE or PET is most common where a silicone rubber stamp is used as the contact transfer head 24, but it should be understood that other compositions for the transfer medium 26 are possible. It is generally desirable that the transfer medium 26 be strong, smooth, and dimensionally stable in order to provide an accurate transfer of the absorber material 27 to the receiving substrate 28, and to prevent the absorber material 27 from coming in direct contact with the silicon die.

Referring now generally to FIGS. 3A-3C, a contact transfer head 124, a transfer medium 126 with a precisely applied desired dye pattern 130, and a receiving substrate 128 are shown. In FIG. 3A, the desired dye pattern 130 is located on the transfer medium 126. In FIG. 3B, the contact transfer head is in contact with the transfer medium 126, which is in contact with the receiving substrate 128. FIG. 3C shows the surface of the transfer medium 126 with the removed dye pattern 131 generally indicated. The removed dye pattern 131 corresponds with the received dye pattern 132 that has been deposited onto the surface of the receiving substrate 128.

In embodiments in which one side of the transfer medium 26 is fully coated with absorber material 27 (see generally FIGS. 2A-2C), proper registration between the contact transfer head 24 and the receiving substrate 28 is not critical. Precision and accuracy of deposition of the absorber material 27 on the receiving substrate 28 depends, in large part, on the precision of the transfer head 24 and registration of the transfer head 24 with the receiving substrate 28, respectively.

In embodiments in which the absorber material 127 is applied to the transfer medium 126 in a desired dye pattern 130, as shown in FIGS. 3A-3C, precise registration is necessary between the transfer medium 126 and receiving substrate 128, but neither the precision of the transfer head 124, nor registration of the transfer head 124 with the receiving substrate 128 is critical.

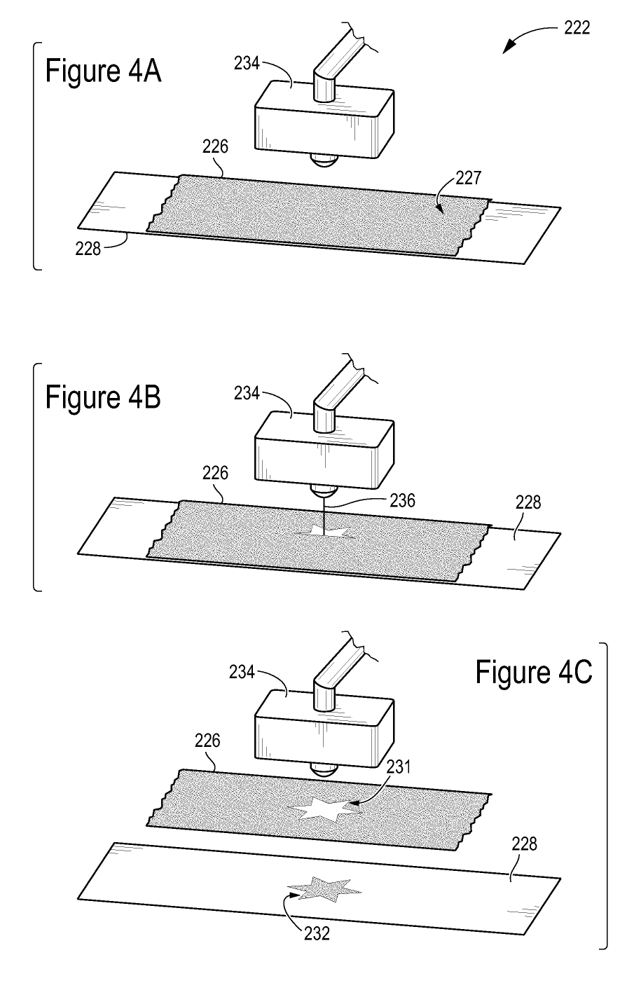

Laser-induced thermal transfer (“LITT”) is an example of a non-contact thermal energy source. Referring generally to FIGS. 4A-7F, a laser source 234 supplies the thermal energy necessary to temporarily transition the absorber material 227 from a solid state to a melted or softened state so that the absorber material 227 is transferred from the transfer medium 226 to the receiving substrate 228.

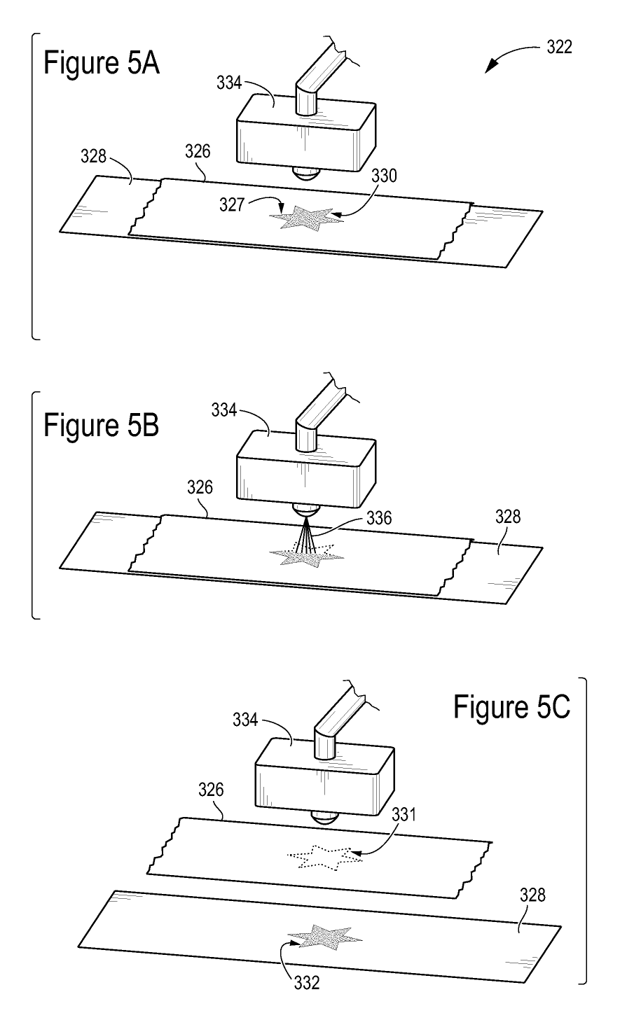

As discussed in greater detail below, the laser source 234 may optionally be capable of a precise “write” mode (see FIG. 4B) and a broader “sweep” mode (see FIG. 5B). The use of the laser source 234 in a write mode allows for the precise transfer of absorber material 227 from the transfer medium 226 to the receiving substrate 228. The laser source 234 can thus be used to deposit complex desired dye patterns 230 onto the receiving substrate 228, for example microfluidic structures. The selected laser source 234 need only be capable of generating the requisite thermal energy to affect the transfer of the absorber material 227 from the transfer medium 226 to the receiving substrate 228.

When a laser source 234 is used as the thermal energy source, limitations on the precision with which the absorber material 227 can be deposited to a receiving substrate 228 depend largely on the optics of the laser source 234. For example, based on testing under laboratory conditions, a FISBA laser, produced by FISBA OPTIK of St. Gall, Switzerland, is able to deposit lines of absorber material 227, each having a width of 400 microns, onto a receiving substrate 228. It should be noted that a laser-welded joint is typically thicker than the width of the deposited line of absorber material 227 used to create the weld.

Referring now generally to FIGS. 4A-4C, a laser source 234, a transfer medium 226 that is fully coated with absorber material 227, and a receiving substrate 228 are shown. In FIG. 4A, the laser source 234 is turned off, and the transfer medium 226 is placed adjacent to the receiving substrate 228 so that the absorber material 227 is in contact with the receiving substrate 228. The laser source 234, being a non-contact heating element, it can be located in a fixed position relative to the targeted parts and does not require the use of a robotic device to move it in the vertical direction (i.e. towards or away from the surface of the transfer medium 226). In FIG. 4B, the laser source 234 is turned on in a precise “write” mode, and the laser beam 236 is shown “writing” the desired dye pattern 230 on the transfer medium 226, which is registered above the receiving substrate 228. The laser source 234 can be guided by an optical guidance system, for example a guidance system developed by FISBA OPTIK of St. Gall, Switzerland. FIG. 4C shows the surface of the transfer medium 226 with the removed dye pattern 231 indicated. The removed dye pattern 231 corresponds with the received dye pattern 232 that has been deposited onto the surface of the receiving substrate 228.

Referring now generally to FIGS. 5A-5C, a laser source 334, a transfer medium 326 with a precisely applied desired dye pattern 330, and a receiving substrate 328 are shown. In FIG. 5A, the laser source 334 is turned off and the desired dye pattern 330 is shown having been applied to the transfer medium 326. The transfer medium 326 is carefully registered on top of the receiving substrate 328. In FIG. 5B, the laser source 334 is turned on, and the laser beam 336 is shown in a broader “sweep” mode. Because the desired dye pattern 330 has been precisely applied to the transfer medium 326 (and because absorber material 327 is absent from the remainder of the transfer medium 326), the desired dye pattern 330 does not have to be traced precisely by the laser beam 336. The entire transfer medium 326 can be irradiated, with the absorber material 327 being transferred in the pattern 330 that had been created on the transfer medium 326. FIG. 5C shows the surface of the transfer medium 326 with the removed dye pattern 331 generally indicated. The removed dye pattern 331 corresponds with the received dye pattern 332 that has been deposited onto the surface of the receiving substrate 328.

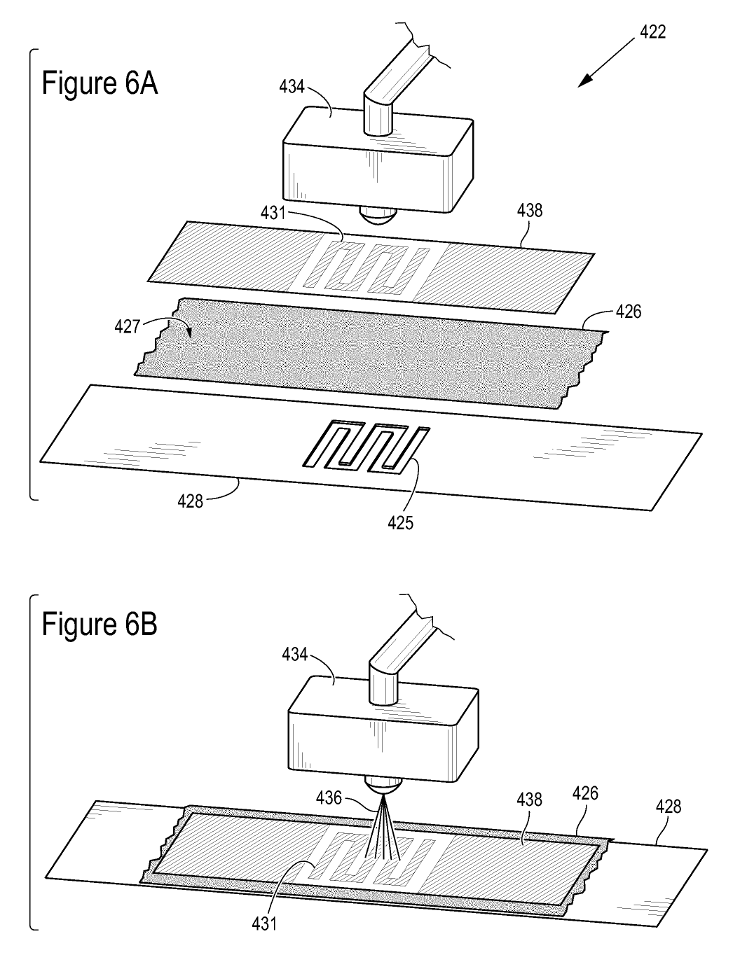

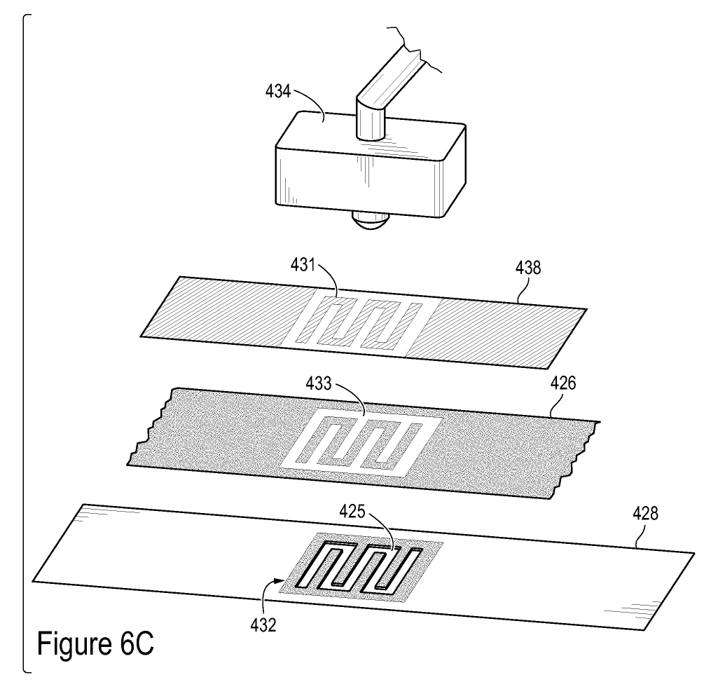

Referring generally to FIGS. 6A-6C, a mask 438 may be used between the laser source 434 and the transfer medium 426 to act as a guide for the transfer of the absorber material 427 from the transfer medium 426 to the receiving substrate 428. The mask 438 is prepared with an image 431 that is a negative of the desired dye pattern 432 and is the same shape as the channels 425 formed in the receiving substrate 428. In FIG. 6A, the laser source 434 is turned off, and the mask 438, transfer medium 426, and receiving substrate 428 are shown in non-adjacent positions.

In FIG. 6B, the mask 438 has been registered on top of the transfer medium 426, which has been registered on top of the receiving substrate 428. The laser source 434 is shown in a broad sweep mode. Because the mask 438 acts as a guide, thereby permitting the laser beam 436 to selectively contact only those portions of the transfer medium 426 that correspond with the desired dye pattern 432 (see FIG. 6C), the laser beam 436 need not be precisely controlled. Where a mask 438 is used, careful registration between the mask 438 and receiving substrate 428 is critical, but registration of the transfer medium 426 and receiving substrate 428 or laser source 434 is not critical. It would be possible to operate the laser source 434 in a write mode when a mask 438 is used for the deposition step, but this is generally not preferred because it substantially slows the deposition process.

In FIG. 6C, the transfer of the desired dye pattern 432 from the transfer medium 426 to the receiving substrate 428 is complete. The transfer medium 426 is shown with the removed dye pattern 433 indicated thereon. The removed dye pattern 433 corresponds with the received dye pattern 432 that has been deposited onto the surface of the receiving substrate 428.

The mask 438 may be made of any material suitable to withstand treatment by the laser source 434, such as for example, any one of a variety of metals or other non-transmissive materials. In addition, the mask 438 may be made of a material that absorbs, disperses and/or reflects laser energy and includes an open area (where the material is removed) in the shape of the removed dye pattern 433. Alternatively, the mask 438 could comprise a laser-transmissive material having a material that absorbs, disperses and/or reflects laser energy applied thereto in a negative of the shape of the removed dye pattern 433. The mask 438 should also be adapted to be dimensionally-stable when exposed to the laser beam 436 and not heated to a degree that would enable the mask 438 itself to effect a thermal transfer of the transfer medium 426.

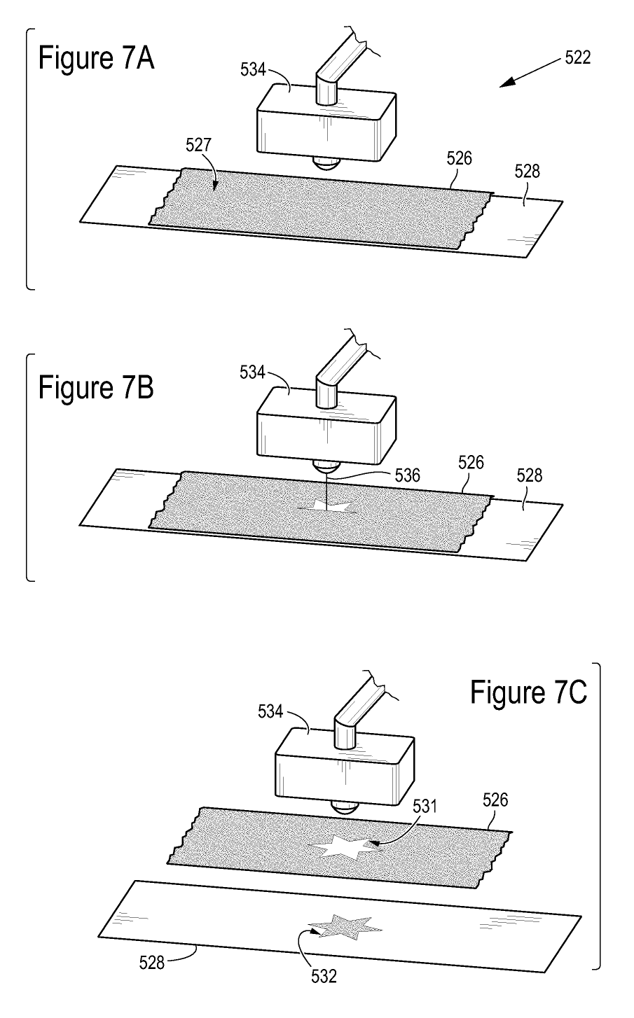

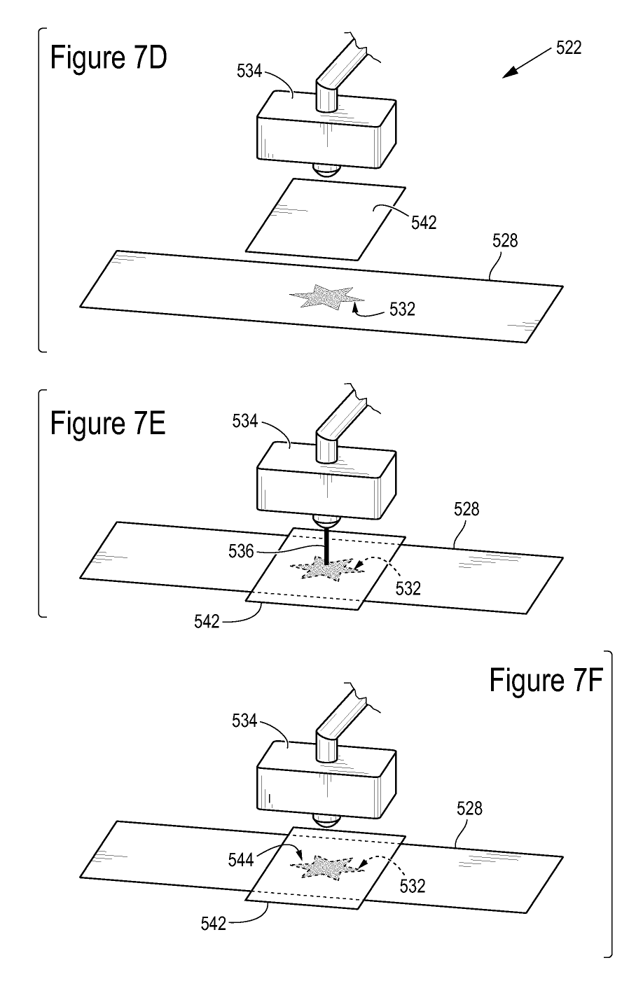

Although it is within the scope of this invention for separate laser sources to be used for the deposition step 16 and the welding step 20, it is preferable that the same laser source 534 (see FIGS. 7A-7F) be used for both of these steps 16, 20. This allows for the work station configuration to be simplified, and reduces the required space. Referring now generally to FIGS. 7A-7F, the deposition step 16 (see FIGS. 7B-7C) and the welding step 20 (see FIGS. 7D-7F) are shown.

FIG. 7A shows a transfer medium 526, which in this embodiment is fully coated with the absorber material 527, and a receiving substrate 528. It should be understood that the transfer medium 526 could alternatively have a desired dye pattern precisely applied thereon. In FIG. 7B, the laser source 534 is activated in a “deposition mode,” which is visually represented by a relatively thin beam 536. When operated in deposition mode, the laser source 534 applies sufficient energy to the absorber material 527, which is a solid on the transfer medium 526, to be temporarily converted into its melted or softened phase. While in a melted or softened phase, the absorber material 527 is transferred to the receiving substrate 528 in the desired dye pattern 530, where it immediately returns to a solid phase.

In FIG. 7C, the transfer of the desired dye pattern 530 from the transfer medium 526 to the receiving substrate 528 is complete. The transfer medium 526 is shown with the removed dye pattern 531 indicated thereon. The removed dye pattern 531 corresponds with the received dye pattern 532 that has been deposited onto the surface of the receiving substrate 528.

In FIG. 7D, a second substrate 542 is shown positioned above the receiving substrate 528, upon which the received dye pattern 532 has been previously deposited. In FIG. 7E, a second substrate 542 has been placed atop (i.e., in contact with) the receiving substrate 528, in a position between the laser source 534 and the received dye pattern 532.

During the step shown in FIG. 7E, the laser source 534 is operated in a “welding mode,” which has a higher energy density than the deposition mode, shown visually by a relatively thick line representing the laser beam 536. The laser beam 536 passes through the second substrate 542, which in this embodiment is devoid of any absorber dye, and therefore laser transmissive, to the received dye pattern 532 that will form the weld area. It should be understood that the laser beam 536 could also be directed initially through the receiving substrate 528 to the area of the received dye pattern 532. The absorber dye is thus activated to affect a weld, in the shape of the dye pattern 532, between the receiving substrate 528 and the second substrate 542. In FIG. 7F, the receiving substrate 528 and second substrate 542 have been welded together to form an affected weld 544.

Many different types of lasers may be used as the laser source 534 for the deposition 16 and/or welding steps 20. Suitable lasers which generally fall into the ultraviolet or visible spectrum could include, but are not limited to, Nd:YAG tripled (354 nm), Nd:YAG doubled (532 nm), Argon (488 and 514 nm), Cu vapor (511 and 578 nm), ruby (694.3 nm), HeNe (632.8 nm), Krypton (647 nm), visible diode (about 600 to 780 nm) and dye (577 to 593 nm) lasers. Suitable near-IR lasers could include, but are not limited to, diode (808 nm, 940 nm, and 980 nm) and Nd:YAG (1064 nm) lasers. It is preferable that laser source 534 emit a wavelength at which the absorber material 527 has an absorbance that is sufficient to allow deposition and welding steps 16, 20 to be completed without melting the receiving or second substrates 528, 542 beyond the weld 544. In order to provide additional flexibility, it is preferable for the laser source 534 to have adjustable beam width and beam power settings.

The “energy density” of the laser source 543 (i.e., the amount of energy applied by the laser to a unit mass of the absorber material 427) is directly proportional to the laser power setting and inversely proportional to the beam size and the speed at which the beam is moved when the beam is active. As explained above, the energy density of the laser source 543 is greater when the laser source 543 is operated in welding mode than when operated in deposition mode. Accordingly, the laser source 543 would be operated at a lower power setting, a larger beam size and/or faster speed when in deposition mode than when in welding mode. The appropriate energy densities for the deposition and welding modes depend upon several factors, including, but not limited to, the absorbance of the absorber material 527 at the wavelength of the laser beam 536, the absorbance of the substrates, and thickness of the substrates.

If all other variables are held constant, using an absorber material having a relatively high absorbance at the wavelength that is emitted by the laser source 543 requires less energy density from the laser source 543 than an absorber material having a relatively low absorbance at the wavelength that is emitted by the laser source 543. Accordingly, in many applications it is preferable for the absorber material to have an absorbance of at least 0.1 and, more preferably, at least 0.2 at the wavelength that is emitted by the laser source 543.

Two examples of appropriate energy density settings for both deposition mode and transfer mode are provided below. In both examples, the laser source is a laser having an operating wavelength of 940 nm and absorber materials (consisting of a single absorber dye) having an absorption of about 0.6 at 940 nm were used.

### EXAMPLE 1

The absorber dye was applied to a transfer film consisting of 5 micron thick PET, deposited to a 1.5 mm thick polycarbonate receiving substrate, then used to weld the receiving substrate to an identical second substrate. For the deposition step, the laser source was operated at a power of 2 Watts, a speed of 50 mm/sec and a beam width of 0.7 mm (corresponding to an energy density of 0.01 J/mm²). For the welding step, the laser source was operated at a power of 40 Watts, a speed of 100 mm/sec and a beam width of 0.7 mm (corresponding to an energy density of 0.57 J/mm²).

### EXAMPLE 2

The absorber dye was applied to a transfer film consisting of 28 micron thick aluminum foil, deposited onto a 3 mm thick acrylic receiving substrate, then used to weld the receiving substrate to an identical second substrate. For the deposition step, the laser source was operated at a power of 50 Watts, a speed of 50 mm/sec and a beam width of 4 mm (corresponding to an energy density of 0.25 J/mm²). For the welding step, the laser source was operated at a power of 100 Watts, a speed of 50 mm/sec and a beam width of 4 mm (corresponding to an energy density of 0.50 J/mm²).

Embodiments of the present invention have shown favorable results when used with several substrates, including polycarbonate (“PC”), polypropylene (“PP”), polymethyl methacrylate (“PMMA,” also commonly known as PLEXIGLAS®), low-density PE, styrene, PETG, and a blend of PE and PP. It should be understood that many other compositions may be used for the receiving substrate within the scope of this invention. In addition, the present invention has shown particular application to the laser-welding of fabrics because much less of the absorber material is absorbed by fabric substrates than would be possible with wet application methods.

As noted above, deposition of an absorber material onto a substrate using a thermal transfer process has several benefits. First, it allows for the absorber material to be transferred to the substrate in a solid or “dry” form, without the need for carrier solvents to be present at the time of transfer. This enables end users to avoid the difficulties associated with handling of solvent waste and vapors. In addition, because the absorber material is in a solid state both immediately before and immediately after the deposition step, the deposited dye will not run, smear, or infuse into the substrate. In addition, the present invention obviates problems relating to impurities left behind by wet dye deposition processes. In specific applications, for example food- and drug-related devices, implantable materials, clothing and apparel, toys, and the like, such omission of potentially toxic leachates is highly desirable. Elimination of the carrier solvent and transfer medium from the weld area has the additional benefit of rendering unnecessary reformulation of the receiving substrate polymer. Omission of the transfer medium further obviates the need to match the miscibility of the transfer medium with the substrates to be joined, and eliminates technical hurdles with respect to the welding process, for example mismatched melting temperatures, heat sinking, or occlusion in the affected weld region.

The methods of the present invention also allow for highly precise deposition of the absorber material onto the receiving substrate, e.g. pixels having a diameter of less than 500 microns or a shape (such as a line) having a minor dimension of less than 500 microns. Such precise application of the absorber material reduces the amount of dye that needs to be used for each application, thus decreasing or eliminating absorber dye runoff or, in the case of textiles, wicking into the fabric of the coated part. This is a valuable benefit because laser-absorbing dyes tend to be very expensive. The high precision afforded by thermal transfer methods allows for the use of laser-welded substrates in micro-fluidic applications. In addition, highly precise welds, e.g. seams, are necessary in certain medical and defense applications, for example biological and chemical suits and respirators.

While the principles of the invention have been described above in connection with preferred embodiments, it is to be clearly understood that this description is made only by way of example and not as a limitation of the scope of the invention.

1. A method comprising:
transferring a first portion of a layer of absorber material from a first surface of a transfer medium to a first portion of a first substrate by exposing the first portion of the layer of absorber material to a thermal energy source while the first portion of the layer of absorber material is in contact with the first portion of the first substrate, the absorber material being in solid phase immediately prior to the transferring step; and
welding the first portion of the first substrate to a second substrate by exposing the first portion of the layer of absorber material to a laser while the first portion of the first substrate is in contact with the second substrate.

2. The method of claim 1, wherein the absorber material consists of the absorber dye.

3. The method of claim 1, wherein the laser emits light at a first wavelength, the absorber dye having an absorbance at the first wavelength of at least 0.1.

4. The method of claim 3, wherein the absorbance of the absorber dye is at least 0.2 at the first wavelength.

5. The method of claim 1, wherein the first and second substrates are comprised of thermoplastic materials.

6. The method of claim 5, wherein the first and second substrates are comprised of thermoplastic materials that are mutually miscible.

7. The method of claim 1, wherein the first and second substrates are selected from the group of: thermoplastic fabrics, thermoplastic coated fabrics and fabrics having thermoplastic coated fibers.

8. The method of claim 7, wherein the first and second substrates are comprised of fabrics that are liquid-absorbent.

9. The method of claim 1, wherein the layer of absorber material covers substantially all of the first surface of the transfer medium immediately prior to the transferring step.

10. The method of claim 1, wherein the layer of absorber material covers an area on the first surface of the transfer medium immediately prior to the transferring step having the shape of the first portion of the first substrate.

11. The method of claim 1, wherein the thermal energy source is a contact thermal energy source.

12. The method of claim 11, wherein the transferring step further comprises contacting a second surface of the thermal transfer medium with the thermal energy source, the second surface opposing the first surface and having no absorber material located thereon.

13. The method of claim 1, wherein the thermal energy source is a non-contact thermal energy source.

14. The method of claim 13, wherein the non-contact thermal energy source is a laser.

15. The method of claim 1, further comprising placing a mask between the thermal energy source and the transfer medium during the transferring step.

16. The method of claim 1, wherein the first portion of the first substrate has a minor dimension of less than 500 micrometers.

17. The method of claim 1, wherein the welding step further comprises positioning the first or second substrate between the laser and the first portion of the layer of absorber material.

18. The method of claim 1, wherein the absorber material further comprises a thermoplastic resin carrier compound.

19. A method comprising:
transferring a first portion of a layer of absorber material from a first surface of a transfer medium to a first portion of a first substrate by exposing the first portion of the layer of absorber material to a laser while the first portion of the layer of absorber material is in contact with the first portion of the first substrate, the absorber material being in solid phase immediately prior to the transferring step and the laser being operated in a deposition mode during the transferring step; and
welding the first portion of the first substrate to a second substrate by exposing the first portion of the layer of absorber material to the laser while the first portion of the first substrate in contact with the second substrate, the laser being operated in a welding mode, the welding mode having a greater energy density than the deposition mode.

20. The method of claim 19, wherein the laser emits light at a first wavelength, the absorber dye having an absorbance at the first wavelength that is at least 0. 1.
